(19) United States
(12) Patent Application Publication
(10) Pub. No.: US 2022/0212103 A1
(43) Pub. Date: Jul. 7, 2022

(54) METHOD FOR PROVIDING BOARD GAME BY MEANS OF SYSTEM USING UNIT POINTS COMMONLY USED IN AND OUT OF GAME AND SERVER USING SAME

(71) Applicant: Wonder People Co., Ltd., Seoul (KR)

(72) Inventor: Min HUR, Seoul (KR)

(73) Assignee: Wonder People Co., Ltd., Seoul (KR)

(21) Appl. No.: 16/485,078

(22) PCT Filed: Feb. 1, 2018
(86) PCT No.: PCT/KR2018/001390

§ 371 Date: Sep. 18, 2019

(30) Foreign Application Priority Data
Feb. 10, 2017 (KR) 10-2017-0018946

(51) Int. Cl. A63F 13/46; A63F 13/69

(52) U.S. Cl. CPC A63F 13/46; A63F 2300/609; A63F 2300/61; A63F 13/69

(57) ABSTRACT

The present invention provides a method for providing a board game by means of a system using unit points commonly used in and out of a game. Provided is a method comprising the steps of: (a) during a first player's play turn, a board game server moving the first player's character over blocks as much as one or more numbers determined in correspondence with the first player; and (b) if a particular block reached by the moved first player's character is a block owned by a second player, the board game server updating profit points or accumulated points for each game recorded in correspondence with the first player by means of subtracting passage points with respect to a passage fee of the particular block and updating profit points or accumulated points for each game recorded in correspondence with the second player by means of adding the passage points.

### FIELD OF THE DISCLOSURE

The present disclosure relates to a method for providing a board game via a board game-providing server adopting unit points used in and out of a round of the board game; and more particularly, to the method for providing the board game, supposing that (i) a first state represents that a first player and a second player log into the board game but do not play the board game and a second state represents that the first player and the second player log into the board game and play the board game, and (ii) the unit points are virtual points capable of being transferred by at least one pathway of (ii-1) transfers among rounding players including the first player and the second player, (ii-2) transfers among the rounding players and the board game-providing server, and (ii-3) transfers among the rounding players and another server connected with the board game-providing server, in the first state and the second state, on condition that either (1) the board game-providing server is recording first and second profit points for a specific round as respectively corresponding to the first player and the second player wherein each of the first and second profit points for the specific round is each sum of the unit points earned or lost respectively by the first player and the second player after the specific round of the board game is started, wherein the specific round is being played together by the first player and the second player, and (2) the board game-providing server is recording first and second accumulated points as respectively corresponding to the first player and the second player wherein each of the first and second accumulated points is each sum of the unit points earned or lost respectively by the first player and the second player in the first state and the second state during a certain period, the board game-providing server, when the first player takes a turn, moves an avatar of the first player on the blocks by at least one number determined as corresponding to the first player and, if a specific block where the avatar of the first player arrives is a block owned by the second player, (i) updates the first profit points for the specific round or the first accumulated points such that toll points corresponding to a toll fee of the specific block is deducted from the first profit points for the specific round or from the first accumulated points, and (ii) updates the second profit points for the specific round or the second accumulated points such that the toll points is added to the second profit points for the specific round or to the second accumulated points, and the board game-providing server using the same.

### BACKGROUND OF THE DISCLOSURE

With recent development of smart devices, a variety of mobile games that can be played on the smart devices are being released, and a field of the mobile games is rapidly growing as the mobile games are steadily gaining popularity.

Board games in the field of the mobile games have simple playing rules and are easy to operate, so people of all ages enjoy them. In particular, the board games such as ‘Marble of All’ and ‘Game of Dice’, which are inspired by the Monopoly, have been steadily gaining popularity. The basic rules are similar to those of the Monopoly, where a player rolls a dice, moves a token or an avatar, buys a block where the token is arrived, constructs a structure, etc., then receives rent or a toll, and wins the game if the player is the richest at the end of the game or other players go bankrupt, but there are additional elements that increase fun of the game.

For example, a player's avatar has a set of functions that can lead the game in the player's favor, that is, the different functions such as acquiring a chance of rolling the dice twice with a small probability or receiving a discount of a construction cost, are configured for each avatar. Thus, the player can increase a possibility of winning the game by acquiring a good avatar, thereby making the game more fun.

However, a game system where the possibility of winning increases simply by acquiring the good avatar induces the player to pay for a better avatar. Thus it has a problem of removing fun elements that could be felt through the Monopoly-like board games.

### SUMMARY OF THE DISCLOSURE

It is an object of the present disclosure to solve all the aforementioned problems.

It is another object of the present disclosure to intrigue a player into a board game by allowing the player to retain and use game points earned within the board game, even after playing the board game.

It is still another object of the present disclosure to provide a revenue model capable of collecting and managing commissions amounting to a part of unit points used in and out of a round of the board game, when said part of the unit points is transferred from one player to another player during the board game.

In order to accomplish objects above and characteristic effects to be described later of the present disclosure, distinctive configurations of the present disclosure are described as follows.

In accordance with one aspect of the present disclosure, there is provided a method for providing a board game via a board game-providing server adopting unit points used in and out of a round of the board game, supposing that (i) the board game provides a plurality of blocks on a board game screen and allows an avatar of a first player and an avatar of a second player to move on the blocks, to construct a structure, and to receive or pay toll fees, (ii) a first state represents that the first player and the second player log into the board game but do not play the board game and a second state represents that the first player and the second player log into the board game and play the board game, and (iii) the unit points are virtual points capable of being transferred by at least one pathway of (iii-1) transfers among rounding players including the first player and the second player, (iii-2) transfers among the rounding players and the board game-providing server, and (iii-3) transfers among the rounding players and another server connected with the board game-providing server, in the first state and the second state, on condition that either (1) the board game-providing server is recording first and second profit points for a specific round as respectively corresponding to the first player and the second player wherein each of the first and second profit points for the specific round is each sum of the unit points earned or lost respectively by the first player and the second player after the specific round of the board game is started, wherein the specific round is being played together by the first player and the second player, and (2) the board game-providing server is recording first and second accumulated points as respectively corresponding to the first player and the second player wherein each of the first and second accumulated points is each sum of the unit points earned or lost respectively by the first player and the second player in the first state and the second state during a certain period, including steps of: (a) the board game-providing server, when the first player takes a turn, moving an avatar of the first player on the blocks by at least one number determined as corresponding to the first player; and (b) the board game-providing server, if a specific block where the avatar of the first player arrives is a block owned by the second player, (i) updating the first profit points for the specific round or the first accumulated points such that toll points corresponding to a toll fee of the specific block is deducted from the first profit points for the specific round or from the first accumulated points, and (ii) updating the second profit points for the specific round or the second accumulated points such that the toll points is added to the second profit points for the specific round or to the second accumulated points.

In accordance with another aspect of the present disclosure, there is provided a board game-providing server for providing a board game via a board game-providing server adopting unit points used in and out of a round of the board game, supposing that (i) the board game provides a plurality of blocks on a board game screen and allows an avatar of a first player and an avatar of a second player to move on the blocks, to construct a structure, and to receive or pay toll fees, (ii) a first state represents that the first player and the second player log into the board game but do not play the board game and a second state represents that the first player and the second player log into the board game and play the board game, and (iii) the unit points are virtual points capable of being transferred by at least one pathway of (iii-1) transfers among rounding players including the first player and the second player, (iii-2) transfers among the rounding players and the board game-providing server, and (iii-3) transfers among the rounding players and another server connected with the board game-providing server, in the first state and the second state, on condition that either (1) the board game-providing server is recording first and second profit points for a specific round as respectively corresponding to the first player and the second player wherein each of the first and second profit points for the specific round is each sum of the unit points earned or lost respectively by the first player and the second player after the specific round of the board game is started, wherein the specific round is being played together by the first player and the second player, and (2) the board game-providing server is recording first and second accumulated points as respectively corresponding to the first player and the second player wherein each of the first and second accumulated points is each sum of the unit points earned or lost respectively by the first player and the second player in the first state and the second state during a certain period, including: a communication part for acquiring at least one input signal from the first player to determine at least one number to be corresponding to the first player when the first player takes a turn; and a processor for performing processes of (I) moving an avatar of the first player on the blocks by said at least one number, placing and displaying the avatar of the first player on a specific block if said at least one number is determined as corresponding to the first player in response to the input signal, (II) if a specific block where the avatar of the first player arrives is a block owned by the second player, (i) updating the first profit points for the specific round or the first accumulated points such that toll points corresponding to a toll fee of the specific block is deducted from the first profit points for the specific round or from the first accumulated points, and (ii) updating the second profit points for the specific round or the second accumulated points such that the toll points is added to the second profit points for the specific round or to the second accumulated points.

### BRIEF DESCRIPTION OF THE DRAWINGS

FIG. 1 is a drawing schematically illustrating a configuration of a board game-providing server in accordance with one example embodiment of the present disclosure.

FIG. 2 is a drawing exemplarily illustrating a board game screen provided to a user device in accordance with one example embodiment of the present disclosure.

FIGS. 3A and 3B are drawings schematically illustrating profit points for a specific round and accumulated points during the board game in accordance with one example embodiment of the present disclosure.

FIG. 4 is a drawing schematically illustrating an entry into a game channel in accordance with one example embodiment of the present disclosure.

FIGS. 5A and 5B are drawings schematically illustrating toll points of a specific block in accordance with one example embodiment of the present disclosure.

FIG. 6 is a drawing schematically illustrating the board game screen which provides a ranking to a player before the board game starts in accordance with one example embodiment of the present disclosure.

FIG. 7 is a drawing schematically illustrating the board game screen providing a general draw and an advanced draw in accordance with one example embodiment of the present disclosure.

FIG. 8 is a drawing schematically illustrating the board game screen which provides reward to the player after the specific round of the board game is terminated in accordance with one example embodiment of the present disclosure.

FIG. 9 is a drawing schematically illustrating the board game screen providing a chance to replenish unit points used in and out of a round of the board game in accordance with one example embodiment of the present disclosure.

### DETAILED DESCRIPTION OF THE PREFERRED EMBODIMENTS

In the following detailed description, reference is made to the accompanying drawings that show, by way of illustration, specific embodiments in which the disclosure may be practiced. These embodiments are described in sufficient detail to enable those skilled in the art to practice the disclosure. It is to be understood that the various embodiments of the present disclosure, although different, are not necessarily mutually exclusive. For example, a particular feature, configuration, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar components throughout the several aspects. As used in this specification and the appended claims, the singular forms “a,” “an,” and “the” include plural referents unless the content and context clearly dictates otherwise. The headings and abstract of the present disclosure provided herein are for convenience only and do not limit or interpret the scope or meaning of the embodiments.

To allow those skilled in the art to the present disclosure to be carried out easily, the example embodiments of the present disclosure by referring to attached diagrams will be explained in detail as shown below.

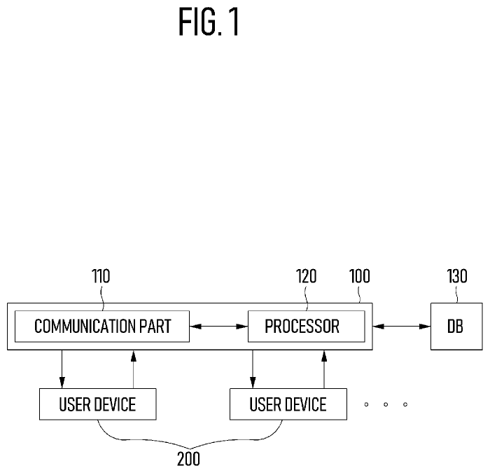

FIG. 1 is a drawing schematically illustrating a configuration of a board game-providing server in accordance with one example embodiment of the present disclosure.

As illustrated in FIG. 1, the board game-providing server 100 of the present disclosure may include a communication part 110 and a processor 120, and unlike FIG. 1, may include a database 130 as the case may be. In addition, the communication part 110 may communicate with a user device 200.

First, the communication part 110 of the board game-providing server 100 may be implemented by various communication technologies. That is, WIFI, WCDMA (Wideband CDMA), HSDPA (High Speed Downlink Packet Access), HSUPA (High Speed Uplink Packet Access), HSPA (High Speed Packet Access), Mobile WiMAX, WiBro, LTE (Long Term Evolution), Bluetooth, IrDA (Infrared Data Association), NFC (Near Field Communication), Zigbee or wireless LAN may be used. Further, if a service is provided over the Internet, TCP/IP, which is a set of standard protocols for transmission of information on the Internet, may be adopted.

Next, the database 130 may be accessible by the communication part 110 of the board game-providing server 100, and the processor 120 is described in detail later.

Meanwhile, the user device 200 in accordance with one example embodiment of the present disclosure may be a digital device capable of connecting and communicating with the board game-providing server 100, and may include any digital device with a processor capable of computation and having a memory, such as a desktop computer, a notebook computer, a workstation, a PDA, a web pad, a mobile phone, etc. Especially, the user device 200 may include a board game related program.

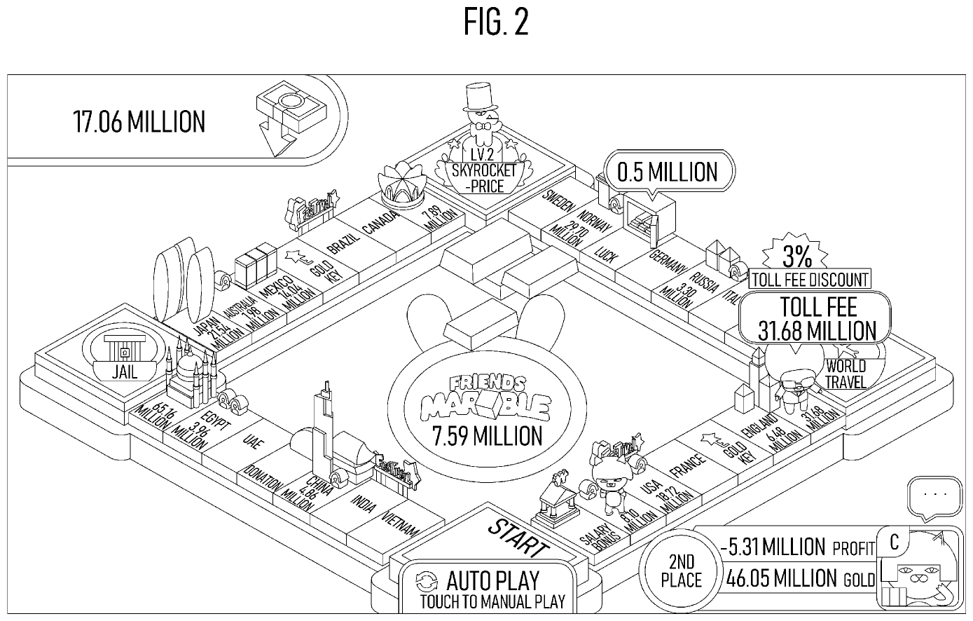

FIG. 2 is a drawing exemplarily illustrating a board game screen provided to the user device 200 in accordance with one example embodiment of the present disclosure.

As shown in FIG. 2, the board game in accordance with one example embodiment of the present disclosure is inspired by the Monopoly. An avatar, i.e., a token, of a player moves on a game board, where a plurality of blocks are arranged, by a dice value; a structure is constructed on a block to which the avatar advances; and if an avatar of another player arrives at the block, an amount corresponding to a toll fee is paid by said another player.

By referring to FIG. 2, at least part of the blocks are shown with information on each of countries, however, unlike FIG. 2, information on each of cities may be displayed, and structures representing eras including a prehistoric era, middle ages, etc. may be built on at least part of the blocks as the case may be.

Also, the blocks may include special effect blocks capable of providing special effects, such as a jail block, a skyrocket-price block, a world travel block, etc. to be described later.

Meanwhile, for convenience of explanation, a first state represents that the player logs in but does not play the board game, and a second state represents that the player logs in and plays the board game, throughout the present specification below and drawings.

That is, the first state represents that the player logs into the board game by inputting an ID and a password but does not proceed with the board game yet or that the player does not log out of the board game after a round of the board game is terminated, and the second state represents that the player plays the round of the board game on the game board where the blocks are arranged as shown in FIG. 2.

Rounding players who are playing the board game together in the second state may include a first player and a second player. More than one rounding players are needed for playing the round the board game, and in general, four rounding players may play the board game together, but the scope of the present disclosure is not limited thereto.

The processor 120 may provide the players with a certain amount of unit points and one or more structure cards. Herein, the unit points which are virtual money may correspond to a minimal unit of electronic money, and the structure cards may include information on structures that can be constructed on at least part of the blocks. Each piece of information on each of the structures may include at least part of a name thereof, an image thereof, a toll fee thereof, etc.

Specifically, the unit points may be a minimal unit of transaction points used in the board game, and may be virtual points capable of being transferred by at least one pathway of (i) transfers among the rounding players including the first player and the second player, (ii) transfers among the rounding players and the board game-providing server, and (iii) transfers among the rounding players and another server connected with the board game-providing server, in the first state and the second state.

Also, the unit points as such may be used in and out of the round of the board game, that is, the unit points used in the round and the unit points used out of the round are integrated and managed, for example, a certain amount of the unit points may be used in the first state to buy a card, e.g., a structure card, and the toll fees used in the second state may be affected by the card purchased in the first state, and such an aspect may be one of major differences from conventional board games.

Meanwhile, the structure card may be acquired by a draw or as a reward, to be described later, in the first state and the second state, and the acquired structure card may be owned by each of the rounding players. Also, each of the rounding players in the second state may construct a structure corresponding to each own structure card of said each of the rounding players.

The processor 120 may record first and second profit points for the specific round as respectively corresponding to the first player and the second player wherein each of the first and second profit points for the specific round is each sum of the unit points earned or lost respectively by the first player and the second player after the specific round of the board game is started, wherein the specific round is being played together by the first player and the second player.

Herein, the profit points for the specific round may be each sum of the unit points earned or lost during from when the specific round of the board game is started to when the specific round is terminated, or from when the specific round of the board game is started to when a certain time period is elapsed, and may be recorded as corresponding to each of the rounding players.

Also, the processor 120 may record first and second accumulated points as respectively corresponding to the first player and the second player wherein each of the first and second accumulated points is each sum of the unit points earned or lost respectively by the first player and the second player in the first state and the second state during a certain period.

Specifically, unlike other conventional board games, the unit points in accordance with the present disclosure may be used when a round of the board game is played as well as when no round of the board game is played. Also, the accumulated points do not disappear when the specific round of the board game is terminated, and an amount of the accumulated points may be a sum of (i) the unit points earned or lost while playing the board game and (ii) the unit points earned or lost while logged in but not playing the board game, during a certain period.

Herein, supposing that the certain period starts from when each of the total players creates an account to be used for playing the board game, the processor 120 may accumulate the unit points earned or lost after creation of each account of the board game by each of the total players, and may record the accumulated points as corresponding to each of the total players. Therefore, each of the total players may have a different certain period from each other according to a point of time of creating the account. As another example, the certain period may be set as other time ranges, beside a time range starting from the creation of the account.

Also, the toll points may represent an amount of the unit points corresponding to a sum of at least part of the toll fee of the block and the toll fee of the structure on the block, and block-purchasing points may represent an amount of the unit points required for acquiring or taking an ownership of the block.

Meanwhile, when the first player takes a turn in the second state, an input signal for determining at least one number to be corresponding to the first player may be acquired from the first player via the communication part 110, and if the at least one number is determined for the first player in response to the input signal, the processor 120 may perform or support another device to perform processes of moving an avatar of the first player on the blocks by the at least one number, placing the avatar on a specific block, then recording and displaying a result of the move.

If the specific block where the avatar of the first player arrives is a block owned by the second player, the processor 120 may perform processes of (i) updating the first profit points for the specific round and/or the first accumulated points such that toll points corresponding to a toll fee of the specific block is deducted from the first profit points for the specific round and/or from the first accumulated points, and (ii) updating the second profit points for the specific round and/or the second accumulated points such that the toll points is added to the second profit points for the specific round and/or to the second accumulated points.

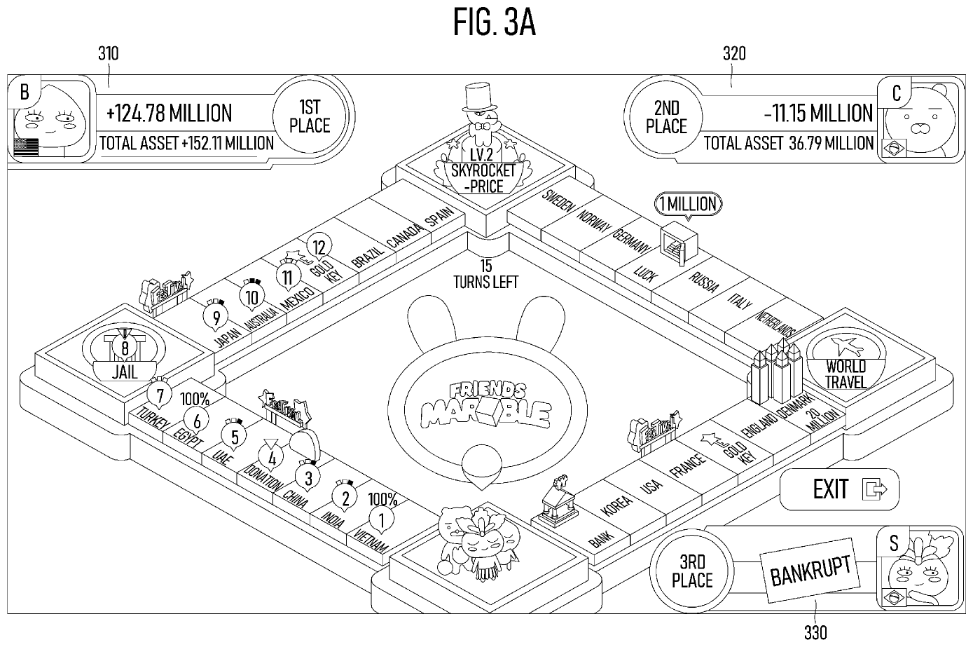

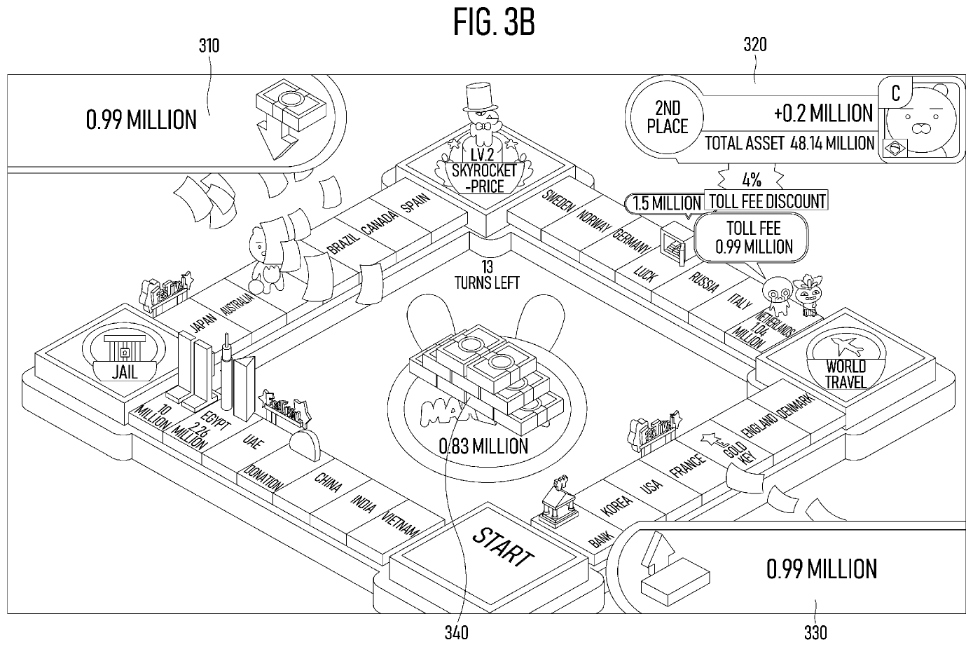

FIG. 3A is a drawing schematically illustrating the profit points for the specific round and the accumulated points during the board game in accordance with one example embodiment of the present disclosure.

A first personal area 310 which is an area corresponding to game information of the first player and a second personal area 320 which is an area corresponding to game information of the second player, etc. may be displayed on the board game screen provided to user devices of the first player and the second player in the second state.

Also, the processor 120 may display or support another device to display (i) the first profit points for the specific round and the first accumulated points of the first player in the first personal area and (ii) the second profit points for the specific round and the second accumulated points of the second player in the second personal area, in real-time while the specific round is being played. Each of the personal areas may display only one of the profit points for the specific round and the accumulated points, according to at least one setting condition, as the case may be.

By referring to FIG. 3A, each of the personal areas may be placed on four corners of the board game screen, and may include each avatar of each of the rounding players, each ID of each of the rounding players, each accumulated points of each of the rounding players, each profit points for the specific round of each of the rounding players, etc. as the game information. The setting condition may determine on which corner of the four corners the game information of the specific player among the rounding players is placed.

For example, by referring to the player of the first personal area 310 in FIG. 3A, the amount of the accumulated points, i.e., a sum of the unit points of the player since the creation of the player's account, is 152.11 million, and the amount of the profit points for the specific round, i.e., a sum of the unit points of the player earned or lost since the specific round currently in session is started, is 124.78 million. Also, by referring to the player of the second personal area 320, the amount of the accumulated points is 36.79 million, and the amount of the profit points for the specific round is −11.15 million. And the player of a third personal area 330 is bankrupt.

Herein, the bankruptcy may represent that the amount of the accumulated points is less than zero, or may represent that the amount of the profit points for the specific round, not the accumulated points, is less than zero according to the setting condition. A bankrupt player cannot play the board game any more, but the rest of the rounding players may proceed with the board game.

Also, the profit points for the specific round and the accumulated points in the personal areas are displayed in real-time while the specific round is played, thus each of the rounding players can confirm in real-time the amount of his/her own accumulated points and the amount of his/her own profit points for the specific round which is a sum of the unit points earned or lost since the specific round is started.

Meanwhile, if the specific block where the avatar of the first player arrives is a block owned by the second player, the board game-providing server 100 may collect a part of the toll points as a commission and then may update the second profit points for the specific round and/or the second accumulated points as increased by an amount of a remaining part of the toll points. Herein, when collecting a part of the toll points as the commission, the commission for an interaction between the rounding players related to the toll fee may be collected right away every time the interaction occurs. This is different from collecting a final commission after a round is terminated in the board game such as a Go-stop card game.

That is, the first player pays the toll fee to the second player, and the board game-providing server which operates the board game acquires a part of the paid toll fee, to thereby earn revenues.

FIG. 3B is a drawing schematically illustrating an animated image representing a transfer of the toll fee during the board game in accordance with one example embodiment of the present disclosure.

The board game screen may include a shared area 340 which is an area corresponding to none of the rounding players and to none of the blocks, in addition to the first personal area 310, the second personal area 320, and the third personal area 330. Herein, the shared area 340 may be a neutral area that does not belong to any player, and may be an area of the board game-providing server.

Meanwhile, if the specific block where the avatar of the first player arrives is a block owned by the second player, the processor 120 may provide or support another device to provide the animated image representing a transfer of the toll points from one among the first personal area 310, the second personal area 320, and the shared area 340 to another one among the first personal area 310, the second personal area 320, and the shared area 340.

By referring to FIG. 3B, the avatar of the third player is shown as arriving at the block of the first player and paying the toll fee, and the processor 120 is shown as providing the animated image representing a transfer of the toll points from the third personal area 330 to the first personal area 310.

Also, to show that the board game-providing server 100 collects a part of the toll points as the commission, the animated image representing a transfer from the third personal area 330 to the shared area 340 may be provided, and then the animated image representing a transfer from the shared area 340 to the first personal area 310 may be provided.

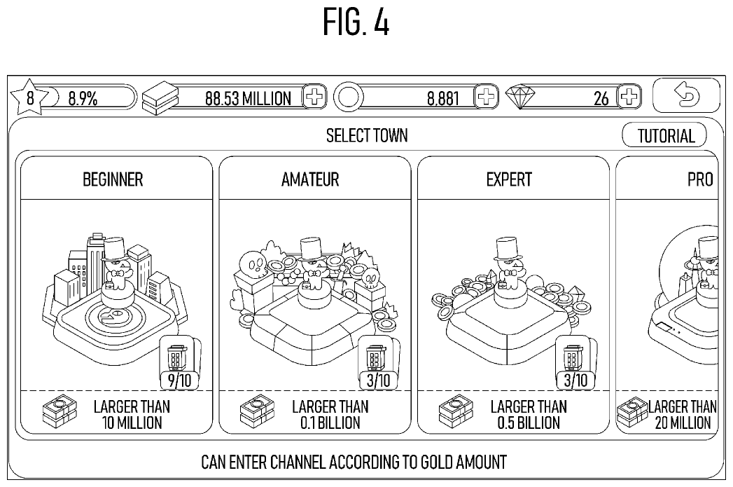

FIG. 4 is a drawing schematically illustrating a scene just before an entry into a game channel in accordance with one example embodiment of the present disclosure.

The processor 120 may determine each level of each of the total players by referring to at least one of the accumulated points and the profit points for the specific round. That is, each level of each of the total players may be determined by referring to each amount of the accumulated points owned by the each of the total players or may be determined by referring to each amount of the profit points for the specific round which is a sum of the unit points earned or lost by each of the total players since the specific round of the board game is started.

Also, the processor 120 may determine and provide the game channels playable by each of the total players by referring to each level of the total players. As can be seen in FIG. 4, if each amount of the accumulated points of each of part of the total players is equal to or greater than 10 million, then each of said part of the total players can enter a beginner's channel, similarly, 0.1 billion for an amateur's channel, and 0.5 billion for an expert's channel.

Herein, supposing that the game channels include a k-th channel and a (k+1)-th channel and that the (k+1)-th channel is an advanced-channel of the k-th channel, the processor 120 may sets at least one increasing rate for (I) at least one of (i) an amount of the block-purchasing points which is a sum of part of the unit points necessary for purchasing at least one of the blocks, (ii) an amount of block-using points which is a sum of part of the unit points necessary for at least one special effect block capable of providing special effects, (iii) a level of an acquired structure card, and (iv) a channel multiplier which is a weight to be used for the toll fee of the structure on the specific block and the toll fee of the specific block wherein the channel multiplier is determined per each game channel, during the second state in the (k+1)-th channel, as higher than that for (II) the amount of the block-purchasing points, the amount of the block-using points, the level of the structure card, and the channel multiplier during the second state in the k-th channel.

This is to maintain tension in the board game and intrigue the players by increasing the sum of the toll points to be traded in the more advanced channel.

First, the amount of the block-purchasing points is a sum of part of the unit points necessary for purchasing at least one of the blocks, and the processor 120 may set a cost of the block as the amount of the block-purchasing points to allow the specific player to buy the block owned by none of the rounding players, however, may set a result of applying a weight to a sum of the toll fee of the block and the toll fee of the structure as the amount of the block-purchasing points to allow the specific player to take an ownership of the block owned by another player.

Next, the amount of the block-using points is a sum of part of the unit points necessary for using the special effects of the special effect block, and may include a cost for breaking a jail on the jail block, a cost for a travel on the world travel block, and an amount of a tax on a tax block, etc.

Also, the structure card may include the information on the structure that can be constructed on the block during the board game, and the higher the level of the structure card is, the higher the probability of the structure, corresponding to the structure card, being constructed on the block in the second state may be.

Also, the channel multiplier may be a weight different for each game channel, to be used for calculating a sum of the toll fee of the structure on the specific block and the toll fee of the specific block.

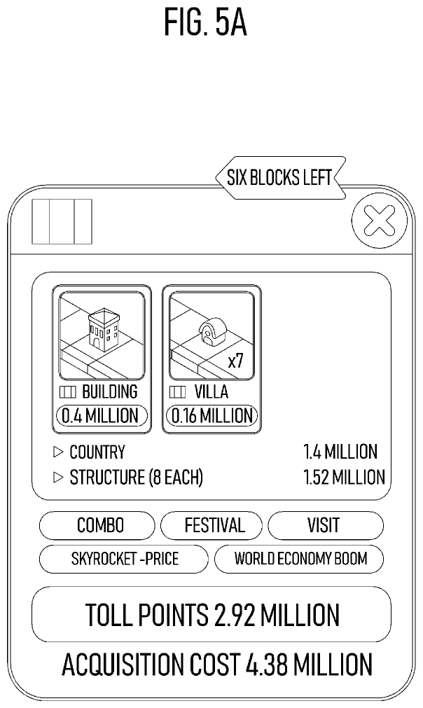

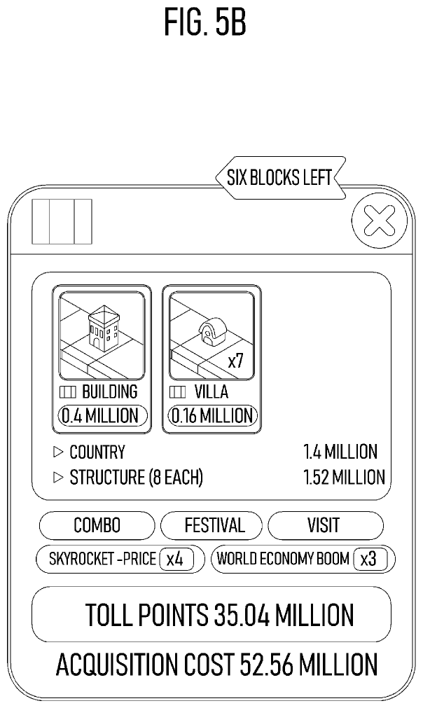

FIG. 5A is a drawing schematically illustrating the toll points of the specific block in accordance with one example embodiment of the present disclosure.

Meanwhile, if a certain condition for allowing a weight to be applied to (i) the toll fee corresponding to the specific block and the toll fee corresponding to the structure on the specific block, (ii) the channel multiplier which is a weight to be applied to the toll fee of the structure on the specific block and to the toll fee of the specific block wherein the channel multiplier is determined per each of the game channels and (iii) the toll fee determined within the specific round, has been satisfied, the toll points may be determined by calculation using a multiplying factor which is a weight to be applied to the toll fee of the structure on the specific block and to the toll fee of the specific block corresponding to the certain condition.

That is, the toll points to be paid if any avatar of the rounding players advances to the block owned by another player may be (i) a sum of the toll fee of the specific block and the toll fee of the structure on the specific block or (ii) a value calculated by applying the channel multiplier and/or the multiplying factor to the sum of the toll fee of the specific block and the toll fee of the structure on the specific block.

By referring to FIG. 5A, the amount of the toll points of the block owned by another player is calculated. First, one building and seven villas are shown as constructed on the block, and the toll fee of the building is 0.4 million, and the toll fee of one villa is 0.16 million, therefore the total toll fee of the structures is 1.52 million. Because the toll fee of a country block is 1.4 million, a sum of the toll fees of the block and the structures is 2.92 million. Supposing that the channel multiplier is 1, the amount of the toll points is said 2.92 million because no multipliers such as a combo are present.

Also, if a weight for an acquisition cost which is part of the block-purchasing points for taking the ownership of the block from another player is 1.5, then said part of the block-purchasing points, i.e., the acquisition cost, is 4.38 million which is equal to 2.92 million times 1.5.

Meanwhile, the multiplying factor is a weight applied to the toll fee if the certain condition is satisfied, and the multiplying factor such as the combo, a festival, a re-visit, a skyrocket-price, a world economy boom, etc. is described as below.

The certain condition may be determined by referring to whether at least one of (i) a condition representing that two or more of the blocks owned by a certain player among the rounding players are connected, (ii) a condition representing that at least part of the blocks are randomly selected when the specific round of the board game is started, (iii) a condition representing that the avatar of a particular player among the rounding players visits a same block, among the blocks owned by the particular player, more than once, (iv) a condition representing that the avatar of an arbitrary player among the rounding players visits a skyrocket-price block which has an effect of increasing the toll points of every block, owned by an especial player among the rounding players, during a period from when the avatar of the especial player visits the skyrocket-price block and to when the avatar of another of the rounding players visits the skyrocket-price block, and (v) a condition representing that a number of game turns remaining until a termination of the round corresponds to a preset number, is satisfied.

First, a combo effect occurs with the restriction of owning two or more connected blocks, and according to the setting condition, the toll fee of two blocks may double if the two blocks are connected, and the toll fee of three blocks may quadruple if the three blocks are connected. Therefore, the toll fee of the connected blocks owned by another player may increase.

Also, when the specific round of the board game starts, at least part of the blocks may be selected as blocks where festivals are held, and the toll fees of the selected blocks may increase.

According to the setting condition, the processor 120 may double the toll fee if the specific player acquires one of the selected blocks and the avatar of another player advances to said one of the selected blocks owned by the specific player, and may quadruple the toll fee if the specific player acquires two of the blocks and the avatar of another player advances to said one among two of the selected block owned by the specific player.

Also, if the avatar of another player re-visits a same block among the blocks owned by said another player, the toll fee of said same block may increase. According to the setting condition, the processor 120 may double the toll fee if the avatar of another player visits the same block twice, and quadruple the toll fee on a third visit.

Also, on condition that the skyrocket-price block is being provided which is the special effect block having an effect of applying a weight to the toll fee of every block owned by the specific player effective from when the avatar of the specific player advances to the skyrocket-price block to when the avatar of another player advances to the skyrocket-price block, if the avatar of said another player is a last to arrive at the skyrocket-price block, the toll fee may increase by a skyrocket-price effect.

Also, if the number of the game turns allowed in a single round of the board game from a start to an end of the round is pre-determined, the toll fees may increase during a second half of the round to increase tension. Therefore, if a time when the number of the game turns remaining until the termination of the round reaches the preset number is assumed as a time of the world economy boom, the processor 120 may increase the toll fees of every block from the time of the world economy boom.

For example, if the number of the game turns allowed in a single round is 20, then the time when the remaining number of the game turns reaches 5 may be assumed as the time of the world economy boom, and the toll fees may increase from then on.

FIG. 5B is a drawing schematically illustrating the toll points of the specific block in accordance with one example embodiment of the present disclosure.

By referring to FIG. 5B, a sum of the toll fees of the block and the structures is 2.92 million, same as in FIG. 5A. However, since a weight of 4 due to the skyrocket-price effect and a weight of 3 due to a world economy boom effect are applied, the amount of the toll points is 35.04 million, and the amount of the block-purchasing points which is the acquisition cost for taking the ownership of the block of another player is 52.56 million which is equal to 35.04 million times 1.5.

Meanwhile, the processor 120 may provide a ranking per a preset period wherein the ranking is of each of total players using the board game or the ranking is of a part of the total players who are set as friends with each of the rounding players, by referring to the accumulated points per each of at least part of the total players and/or the profit points for the specific round per each of at least part of the total players.

Herein, the preset period used for providing the ranking may be set as a week, a month, etc. according to the setting condition, and the processor 120 may provide a position of the specific player in the ranking by referring to the accumulated points of the specific player during the preset period.

Also, the processor 120 may provide the ranking to each of the total players, by referring to each round with the largest profit points for a round, among multiple rounds which are played by each of the total players during the preset period, of the board game.

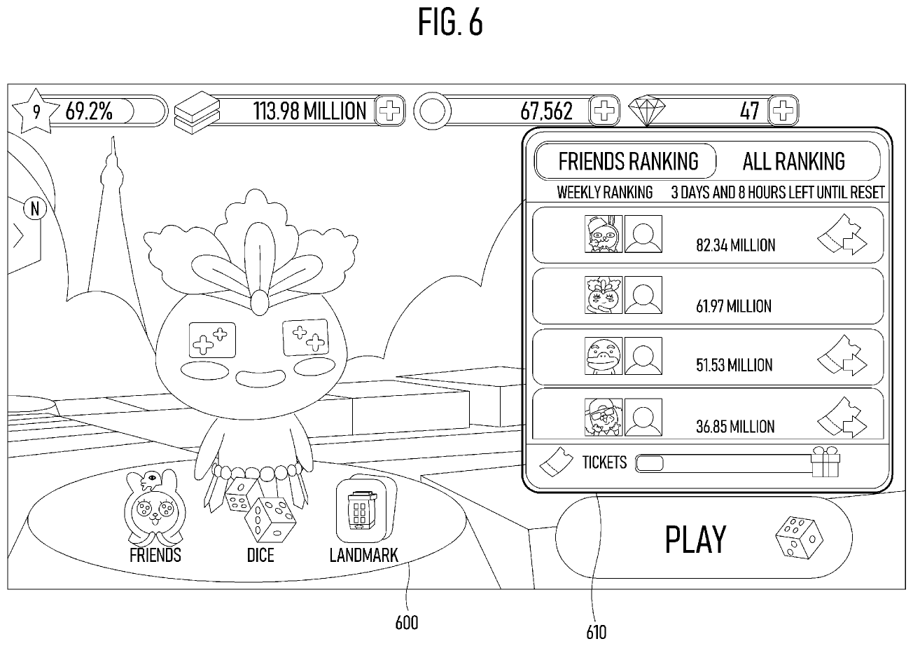

FIG. 6 is a drawing schematically illustrating the board game screen which provides the ranking to the specific player before the board game starts in accordance with one example embodiment of the present disclosure.

By referring to FIG. 6, the processor 120 may provide the ranking of each of the total players, or may provide the ranking of each of the players set as friends with the rounding players. The avatar of the player, the ID of the player, the accumulated points or the profit points for the specific round of the player, etc. may be displayed on a user interface 610 which provides the ranking.

Also, when the ranking of the total players is provided, the processor 120 may provide or support another device to provide the reward to a part of the total players whose numbered position in the ranking in ascending order is smaller than a predetermined number, and may provide the reward in a discriminatory manner according to the number of a part of the total players set as the friends with each of the rounding players or to the number of the total players.

That is, the processor 120 may provide the reward to the players positioned in a higher part of the ranking, and the amount of the reward may vary according to a size of the total players used in generating the ranking.

For example, the reward with a greater weight may be provided to a top-ranking player among a thousand of the total players than to a top-ranking player among a hundred of the total players.

Herein, the reward may include the avatar, the avatar item, the structure card, etc. and may also include the consumable items such as an item for increasing a probability of an outcome of a double in a dice roll and an item for exempting a player from the toll fee once.

Meanwhile, the number of the game turns allowed in a single round of the board game may be preset, and if the allowed number of the game turns are exhausted, the round may be terminated.

However, if the game turns are exhausted, the processor 120 may allow one of the rounding players to suggest an additional number of the game turns up to a prearranged number to rest of the rounding players, and if approval from the rest of the rounding players is detected, may allow the rounding players to play a round of the board game as many as the additional number of the game turns.

That is, even if the game turns are exhausted, the processor 120 may provide at least one of the rounding players with a chance to continue playing the board game, and if the rest of the rounding players approve, may allow the rounding players to continue playing the round. As one example, according to the setting condition, only a player top among the rounding players may be allowed to suggest the additional number of the game turns. As another example, the rounding players may be allowed to play the additional number of the game turns even though only a part of the rest of the rounding players approve.

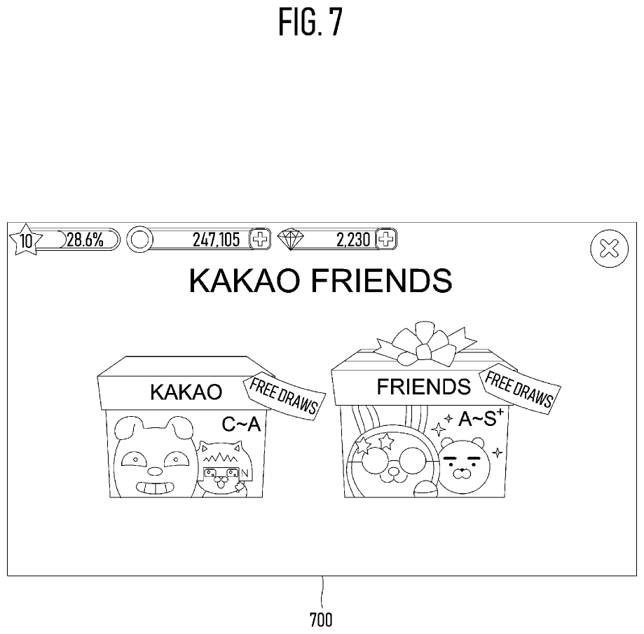

FIG. 7 is a drawing schematically illustrating the board game screen providing a general draw and an advanced draw in accordance with one example embodiment of the present disclosure.

Supposing that a specific player is one of the first player and the second player, that specific profit points for the specific round belong to the specific player, and that specific accumulated points belong to the specific player, the processor 120, by using the specific profit points for the specific round or the specific accumulated points, may allow the specific player to (i) acquire the avatar corresponding to the specific player while in the first state and/or the second state, (ii) acquire the avatar item to be used for the avatar corresponding to the specific player while in the first state and/or the second state, (iii) acquire the structure card while in the first state and/or the second state, or (iv) perform or support another device to perform one or more draws for acquiring the consumable items to be used in the second state.

Herein, the draws may be performed by deducting at least part of the unit points during the first state and/or the second state, and if the draws are performed, then the avatar, the avatar item, the structure card, and the consumable items may be provided. The draws may be performed randomly by default, however, may be performed according to a certain criterion. The aspect of acquiring the avatar, the avatar item, the structure card, the consumable items, etc. by using a part of the unit points which cannot be purchased with money in general is what distinguishes the present disclosure from other similar board games. Clearly, the unit points may be purchased with money as the case may be.

The draws may include the general draw and the advanced draw. Herein, a sum of the unit points required for the advanced draw may be larger than a sum of the unit points required for the general draw.

Also, the processor 120 may provide (i) the avatar, the avatar item, the structure card or the consumable items acquirable via the advanced draw and (ii) the avatar, the avatar item, the structure card or the consumable items acquirable via the general draw, in a discriminatory manner.

That is, a basic avatar, the avatar item for the basic avatar, the structure card with a low level, or basic consumable items may be acquired from the general draw, and an advanced avatar, the avatar item for the advanced avatar, the structure card with a high level, or advanced consumable items may be acquired from the advanced draw.

Also, the processor 120 may record ranking information determined by referring to each of the profit points for a round of each of the total players. Specifically, a rank of one of the rounding players who acquires more of the unit points from the start of the specific round of the board game may be set as higher.

Supposing that a specific player is one of the first player and the second player, that specific profit points for the specific round belong to the specific player, and that specific accumulated points belong to the specific player, according to the rank information, the processor 120 may provide or support another device to provide the specific player with at least one of (i) a rewarding amount of the unit points, (ii) the structure card corresponding to the structure, (iii) an amount of Cons which is electronic money to be used for purchasing the items, and (iv) an amount of experience points to be used for increasing the level of the specific player, in a discriminatory manner.

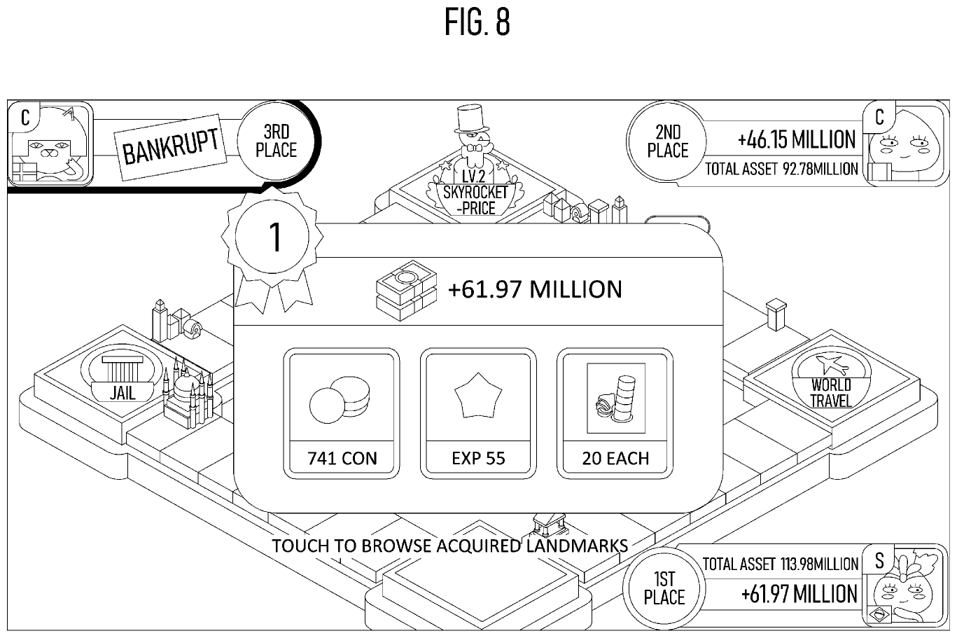

FIG. 8 is a drawing schematically illustrating the board game screen which provides the ranking to the specific player after the specific round of the board game is terminated in accordance with one example embodiment of the present disclosure.

By referring to FIG. 8, the player having the profit points for the specific round amounting to 61.97 million is selected as the top player, and the processor 120 provides the top player with 741 Cons, 55 experience points, and 20 structure cards.

For reference, the players may buy the items with Cons and may buy Cons with real money.

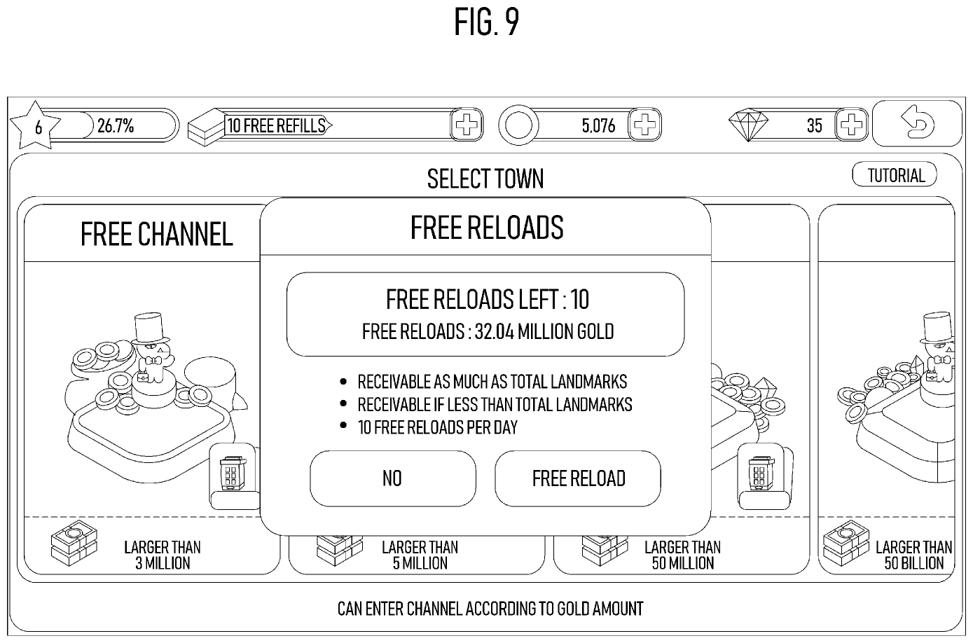

FIG. 9 is a drawing schematically illustrating the board game screen providing a chance to replenish the unit points used in and out of the round of the board game in accordance with one example embodiment of the present disclosure.

Also, supposing that a specific player is one of the first player and the second player and that specific accumulated points belong to the specific player, if an amount of the specific accumulated points is determined as less than a sum of the toll points corresponding to all structure cards owned by the specific player, the processor 120 may update, for a preplanned number of times, the specific accumulated points as increased by a sum of the unit points corresponding to the sum of the toll points corresponding to the structure card owned by the specific player.

For example, if a certain player has 3 structure cards whose toll points are 1.2 million, 0.8 million, and 2 million, and 3 million accumulated points, the processor 120 may update the accumulated points of the player to 7 million, increased by 4 million, for the preplanned number of times.

For reference, the number of chances to replenish the unit points may be set as 10 per day, but if the chances are exhausted, the chances may be bought with real money.

The present disclosure has an effect of intriguing the player into the board game by allowing the player to retain and use game points earned within the board game, even after playing the board game.

The present disclosure has another effect of providing a revenue model capable of collecting and managing commissions amounting to a part of the unit points used in and out of the round of the board game, when the part of the unit points is transferred from one player to another player during the board game.

The embodiments of the present disclosure as explained above can be implemented in a form of executable program command through a variety of computer means recordable in computer readable media. The computer readable media may include solely or in combination, program commands, data files, and data structures. The program commands recorded in the media may be components specially designed for the present disclosure or may be usable to those skilled in the art in a field of computer software. Computer readable media may include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands may include not only a machine language code made by a complier but also a high level code that can be used by an interpreter etc., which may be executable by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for providing a board game via a board game-providing server adopting unit points used in and out of a round of the board game, supposing that (i) the board game provides a plurality of blocks on a board game screen and allows an avatar of a first player and an avatar of a second player to move on the blocks, to construct a structure, and to receive or pay toll fees, (ii) a first state represents that the first player and the second player log into the board game but do not play the board game and a second state represents that the first player and the second player log into the board game and play the board game, and (iii) the unit points are virtual points capable of being transferred by at least one pathway of (iii-1) transfers among rounding players including the first player and the second player, (iii-2) transfers among the rounding players and the board game-providing server, and (iii-3) transfers among the rounding players and another server connected with the board game-providing server, in the first state and the second state,
on condition that either (1) the board game-providing server is recording first and second profit points for a specific round as respectively corresponding to the first player and the second player wherein each of the first and second profit points for the specific round is each sum of the unit points earned or lost respectively by the first player and the second player after the specific round of the board game is started, wherein the specific round is being played together by the first player and the second player, and (2) the board game-providing server is recording first and second accumulated points as respectively corresponding to the first player and the second player wherein each of the first and second accumulated points is each sum of the unit points earned or lost respectively by the first player and the second player in the first state and the second state during a certain period, comprising steps of:
(a) the board game-providing server, when the first player takes a turn, moving an avatar of the first player on the blocks by at least one number determined as corresponding to the first player; and
(b) the board game-providing server, if a specific block where the avatar of the first player arrives is a block owned by the second player, (i) updating the first profit points for the specific round or the first accumulated points such that toll points corresponding to a toll fee of the specific block is deducted from the first profit points for the specific round or from the first accumulated points, and (ii) updating the second profit points for the specific round or the second accumulated points such that the toll points is added to the second profit points for the specific round or to the second accumulated points.

2. The method of claim 1, wherein, on condition that a first personal area which is an area corresponding to game information of the first player and a second personal area which is an area corresponding to game information of the second player have been displayed on the board game screen provided to user devices of the first player and the second player in the second state, the board game-providing server displays or supports another device to display (i) the first profit points for the specific round and the first accumulated points in the first personal area and (ii) the second profit points for the specific round and the second accumulated points in the second personal area, in real-time while the specific round is being played.

3. The method of claim 2, wherein, supposing that a specific player is one of the first player and the second player, that specific profit points for the specific round belong to the specific player, that specific accumulated points belong to the specific player, and that a level of the specific player is determined by at least one of the specific accumulated points and the specific profit points for the specific round, the board game-providing server determines and provides one or more game channels capable of being played by the specific player by referring to the level of the specific player, and
wherein, supposing that the game channels include a k-th channel and a (k+1)-th channel and that the (k+1)-th channel is an advanced-channel of the k-th channel, the board game-providing server sets at least one increasing rate for (I) at least one of (i) an amount of block-purchasing points which is a sum of part of the unit points necessary for purchasing at least one of the blocks, (ii) an amount of block-using points which is a sum of part of the unit points necessary for at least one special effect block capable of providing special effects, (iii) a level of an acquired structure card, and (iv) a channel multiplier which is a weight to be used for the toll fee of the structure on the specific block and the toll fee of the specific block wherein the channel multiplier is determined per each game channel, during the second state in the (k+1)-th channel, as higher than that for (II) the amount of the block-purchasing points, the amount of the block-using points, the level of the structure card, and the channel multiplier during the second state in the k-th channel.

4. The method of claim 1, wherein the board game-providing server provides one or more game channels, and
wherein, if a certain condition for allowing a weight to be applied to (i) the toll fee corresponding to the specific block and the toll fee corresponding to the structure on the specific block, (ii) a channel multiplier which is a weight to be applied to the toll fee of the structure on the specific block and to the toll fee of the specific block wherein the channel multiplier is determined per each of the game channels and (iii) the toll fee determined within the specific round, has been satisfied,
the toll points are determined by calculation using a multiplying factor which is a weight to be applied to the toll fee of the structure on the specific block and to the toll fee of the specific block corresponding to the certain condition.

5. The method of claim 4, wherein the certain condition is determined by referring to whether at least one of (i) a condition representing that two or more of the blocks owned by a certain player among the rounding players are connected, (ii) a condition representing that at least part of the blocks are randomly selected when the specific round of the board game is started, (iii) a condition representing that an avatar of a particular player among the rounding players visits a same block, among the blocks owned by the particular player, more than once, (iv) a condition representing that an avatar of an arbitrary player among the rounding players visits a skyrocket-price block which has an effect of increasing the toll points of every block, owned by an especial player among the rounding players, during a period from when an avatar of the especial player visits the skyrocket-price block and to when an avatar of another of the rounding players visits the skyrocket-price block, and (v) a condition representing that a number of game turns remaining until a termination of the round corresponds to a preset number, is satisfied.

6. The method of claim 1, wherein the board game-providing server provides a ranking per a preset period wherein the ranking is of each of total players using the board game or the ranking is of a part of the total players who are set as friends with each of the rounding players, by referring to accumulated points per each of at least part of the total players or profit points for the specific round per each of at least part of the total players.

7. The method of claim 6, wherein, when the ranking of the total players is provided, the board game-providing server provides or supports another device to provide reward to a part of the total players whose numbered position in the ranking in ascending order is smaller than a preset number, and provides the reward in a discriminatory manner according to the number of a part of the total players set as the friends with each of the rounding players or to the number of the total players.

8. The method of claim 1, wherein, on condition that the number of game turns allowed in a single round of the board game has been predetermined, if the game turns are exhausted, the board game-providing server allows one of the rounding players to suggest an additional number of the game turns up to a predetermined number to rest of the rounding players, and if approval from the rest of the rounding players is detected, allows the rounding players to play a round of the board game as many as the additional number of the game turns.

9. The method of claim 1, wherein, supposing that a specific player is one of the first player and the second player, that specific profit points for the specific round belong to the specific player, and that specific accumulated points belong to the specific player, the board game-providing server, by using the specific profit points for the specific round or the specific accumulated points, allows the specific player to (i) acquire an avatar corresponding to the specific player while in the first state or the second state, (ii) acquire an avatar item to be used for the avatar corresponding to the specific player while in the first state or the second state, (iii) acquire a structure card while in the first state or the second state, or (iv) perform or support another device to perform one or more draws for acquiring one or more consumable items to be used in the second state.

10. The method of claim 9, wherein the draws include a general draw and an advanced draw, wherein a sum of the unit points required for the advanced draw is larger than a sum of the unit points required for the general draw, and wherein the board game-providing server provides the avatar, the avatar item, the structure card or the consumable items acquirable via the advanced draw and the avatar, the avatar item, the structure card or the consumable items acquirable via the general draw in a discriminatory manner.

11. The method of claim 1, wherein, supposing that a specific player is one of the first player and the second player, that specific profit points for the specific round belong to the specific player, and that specific accumulated points belong to the specific player, the board game-providing server (i) records rank information determined by referring to the specific profit points for the specific round in the second state, and (ii) according to the rank information, provides or supports another device to provide the specific player with at least one of (ii-1) a rewarding amount of the unit points, (ii-2) a structure card corresponding to the structure, (ii-3) a Con which is electronic money to be used for purchasing items, and (ii-4) an amount of experience points to be used for increasing a level of the specific player, in a discriminatory manner.

12. The method of claim 1, wherein, supposing that a specific player is one of the first player and the second player and that specific accumulated points belong to the specific player, while in the first state, if an amount of the specific accumulated points is determined as less than a sum of the toll points corresponding to all structure cards owned by the specific player, the board game-providing server updates, for a preset number of times, the specific accumulated points as increased by a sum of the unit points corresponding to the sum of the toll points corresponding to the structure card owned by the specific player.

13. The method of claim 1, wherein, at the step of (b), if the specific block where the avatar of the first player arrives is a block owned by the second player, the board game-providing server collects a part of the toll points and then updates the second profit points for the specific round or the second accumulated points as increased by an amount of a remaining part of the toll points.

14. The method of claim 1, wherein, at the step of (b), on condition that the board game screen provided to user devices of the first player and the second player in the second state includes (i) a first personal area which is an area corresponding to game information of the first player (ii) a second personal area which is an area corresponding to game information of the second player, and (iii) a shared area which is an area corresponding to none of the rounding players and to none of the blocks, and on condition that the specific block where the avatar of the first player arrives is a block owned by the second player,
the board game-providing server provides or supports another device to provide an animated image representing a transfer of the toll points from one among the first personal area, the second personal area, and the shared area to another one among the first personal area, the second personal area, and the shared area.

15. The method of claim 1, wherein each of the blocks on the board game screen provided to user devices of the first player and the second player corresponds to information on each of countries or information on each of cities.

16. A board game-providing server for providing a board game via a board game-providing server adopting unit points used in and out of a round of the board game, supposing that (i) the board game provides a plurality of blocks on a board game screen and allows an avatar of a first player and an avatar of a second player to move on the blocks, to construct a structure, and to receive or pay toll fees, (ii) a first state represents that the first player and the second player log into the board game but do not play the board game and a second state represents that the first player and the second player log into the board game and play the board game, and (iii) the unit points are virtual points capable of being transferred by at least one pathway of (iii-1) transfers among rounding players including the first player and the second player, (iii-2) transfers among the rounding players and the board game-providing server, and (iii-3) transfers among the rounding players and another server connected with the board game-providing server, in the first state and the second state,
on condition that either (1) the board game-providing server is recording first and second profit points for a specific round as respectively corresponding to the first player and the second player wherein each of the first and second profit points for the specific round is each sum of the unit points earned or lost respectively by the first player and the second player after the specific round of the board game is started, wherein the specific round is being played together by the first player and the second player, and (2) the board game-providing server is recording first and second accumulated points as respectively corresponding to the first player and the second player wherein each of the first and second accumulated points is each sum of the unit points earned or lost respectively by the first player and the second player in the first state and the second state during a certain period, comprising:
a communication part for acquiring at least one input signal from the first player to determine at least one number to be corresponding to the first player when the first player takes a turn; and
a processor for performing processes of (I) moving an avatar of the first player on the blocks by said at least one number, placing and displaying the avatar of the first player on a specific block if said at least one number is determined as corresponding to the first player in response to the input signal, (II) if a specific block where the avatar of the first player arrives is a block owned by the second player, (i) updating the first profit points for the specific round or the first accumulated points such that toll points corresponding to a toll fee of the specific block is deducted from the first profit points for the specific round or from the first accumulated points, and (ii) updating the second profit points for the specific round or the second accumulated points such that the toll points is added to the second profit points for the specific round or to the second accumulated points.

17. The board game-providing server of claim 16, wherein, on condition that a first personal area which is an area corresponding to game information of the first player and a second personal area which is an area corresponding to game information of the second player have been displayed on the board game screen provided to user devices of the first player and the second player in the second state, the processor displays or supports another device to display (i) the first profit points for the specific round and the first accumulated points in the first personal area and (ii) the second profit points for the specific round and the second accumulated points in the second personal area, in real-time while the specific round is being played.

18. The board game-providing server of claim 17, wherein, supposing that a specific player is one of the first player and the second player, that specific profit points for the specific round belong to the specific player, that specific accumulated points belong to the specific player, and that a level of the specific player is determined by at least one of the specific accumulated points and the specific profit points for the specific round, the processor determines and provides one or more game channels capable of being played by the specific player by referring to the level of the specific player, and
wherein, supposing that the game channels include a k-th channel and a (k+1)-th channel and that the (k+1)-th channel is an advanced-channel of the k-th channel, the processor sets at least one increasing rate for (I) at least one of (i) an amount of block-purchasing points which is a sum of part of the unit points necessary for purchasing at least one of the blocks, (ii) an amount of block-using points which is a sum of part of the unit points necessary for at least one special effect block capable of providing special effects, (iii) a level of an acquired structure card, and (iv) a channel multiplier which is a weight to be used for the toll fee of the structure on the specific block and the toll fee of the specific block wherein the channel multiplier is determined per each game channel, during the second state in the (k+1)-th channel, as higher than that for (II) the amount of the block-purchasing points, the amount of the block-using points, the level of the structure card, and the channel multiplier during the second state in the k-th channel.

19. The board game-providing server of claim 16, wherein the processor provides one or more game channels, and
wherein, if a certain condition for allowing a weight to be applied to (i) the toll fee corresponding to the specific block and the toll fee corresponding to the structure on the specific block, (ii) a channel multiplier which is a weight to be applied to the toll fee of the structure on the specific block and to the toll fee of the specific block wherein the channel multiplier is determined per each of the game channels and (iii) the toll fee determined within the specific round, has been satisfied,
the toll points are determined by calculation using a multiplying factor which is a weight to be applied to the toll fee of the structure on the specific block and to the toll fee of the specific block corresponding to the certain condition.

20. The board game-providing server of claim 19, wherein the certain condition is determined by referring to whether at least one of (i) a condition representing that two or more of the blocks owned by a certain player among the rounding players are connected, (ii) a condition representing that at least part of the blocks are randomly selected when the specific round of the board game is started, (iii) a condition representing that an avatar of a particular player among the rounding players visits a same block, among the blocks owned by the particular player, more than once, (iv) a condition representing that an avatar of an arbitrary player among the rounding players visits a skyrocket-price block which has an effect of increasing the toll points of every block, owned by an especial player among the rounding players, during a period from when an avatar of the especial player visits the skyrocket-price block and to when an avatar of another of the rounding players visits the skyrocket-price block, and (v) a condition representing that a number of game turns remaining until a termination of the round corresponds to a preset number, is satisfied.

21. The board game-providing server of claim 16, wherein the processor provides a ranking per a preset period wherein the ranking is of each of total players using the board game or the ranking is of a part of the total players who are set as friends with each of the rounding players, by referring to accumulated points per each of at least part of the total players or profit points for the specific round per each of at least part of the total players.

22. The board game-providing server of claim 21, wherein, when the ranking of the total players is provided, the processor provides or supports another device to provide reward to a part of the total players whose numbered position in the ranking in ascending order is smaller than a preset number, and provides the reward in a discriminatory manner according to the number of a part of the total players set as the friends with each of the rounding players or to the number of the total players.

23. The board game-providing server of claim 16, wherein, on condition that the number of game turns allowed in a single round of the board game has been predetermined, if the game turns are exhausted, the processor allows one of the rounding players to suggest an additional number of the game turns up to a predetermined number to rest of the rounding players, and if approval from the rest of the rounding players is detected, allows the rounding players to play a round of the board game as many as the additional number of the game turns.

24. The board game-providing server of claim 16, wherein, supposing that a specific player is one of the first player and the second player, that specific profit points for the specific round belong to the specific player, and that specific accumulated points belong to the specific player, the processor, by using the specific profit points for the specific round or the specific accumulated points, allows the specific player to (i) acquire an avatar corresponding to the specific player while in the first state or the second state, (ii) acquire an avatar item to be used for the avatar corresponding to the specific player while in the first state or the second state, (iii) acquire a structure card while in the first state or the second state, or (iv) perform or support another device to perform one or more draws for acquiring one or more consumable items to be used in the second state.

25. The board game-providing server of claim 24, wherein the draws include a general draw and an advanced draw, wherein a sum of the unit points required for the advanced draw is larger than a sum of the unit points required for the general draw, and wherein the processor provides the avatar, the avatar item, the structure card or the consumable items acquirable via the advanced draw and the avatar, the avatar item, the structure card or the consumable items acquirable via the general draw in a discriminatory manner.

26. The board game-providing server of claim 16, wherein, supposing that a specific player is one of the first player and the second player, that specific profit points for the specific round belong to the specific player, and that specific accumulated points belong to the specific player, the processor (i) records rank information determined by referring to the specific profit points for the specific round in the second state, and (ii) according to the rank information, provides or supports another device to provide the specific player with at least one of (ii-1) a rewarding amount of the unit points, (ii-2) a structure card corresponding to the structure, (ii-3) a Con which is electronic money to be used for purchasing items, and (ii-4) an amount of experience points to be used for increasing a level of the specific player, in a discriminatory manner.

27. The board game-providing server of claim 16, wherein, supposing that a specific player is one of the first player and the second player and that specific accumulated points belong to the specific player, while in the first state, if an amount of the specific accumulated points is determined as less than a sum of the toll points corresponding to all structure cards owned by the specific player, the processor updates, for a preset number of times, the specific accumulated points as increased by a sum of the unit points corresponding to the sum of the toll points corresponding to the structure card owned by the specific player.

28. The board game-providing server of claim 16, wherein, at the process of (II), if the specific block where the avatar of the first player arrives is a block owned by the second player, the processor collects a part of the toll points and then updates the second profit points for the specific round or the second accumulated points as increased by an amount of a remaining part of the toll points.

29. The board game-providing server of claim 16, wherein, at the process of (II), on condition that the board game screen provided to user devices of the first player and the second player in the second state includes (i) a first personal area which is an area corresponding to game information of the first player (ii) a second personal area which is an area corresponding to game information of the second player, and (iii) a shared area which is an area corresponding to none of the rounding players and to none of the blocks, and on condition that the specific block where the avatar of the first player arrives is a block owned by the second player,
the processor provides or supports another device to provide an animated image representing a transfer of the toll points from one among the first personal area, the second personal area, and the shared area to another one among the first personal area, the second personal area, and the shared area.

30. The board game-providing server of claim 16, wherein each of the blocks on the board game screen provided to user devices of the first player and the second player corresponds to information on each of countries or information on each of cities.
